(19) United States
(12) Patent Application Publication
(10) Pub. No.: US 2003/0097508 A1
(43) Pub. Date: May 22, 2003

(54) Dynamically configuring processor resources

(76) Inventor: Nicholas E. Aneshansley, San Diego, CA (US)

Correspondence Address: B. NOEL KIVLIN, MEYERTONS, HOOD, KIVLIN, KOWERT & GOETZEL , P.C., P.O. BOX 398, AUSTIN, TX, 78767, US

(21) Appl. No.: 09/992,439

(22) Filed: Nov. 16, 2001

(51) Int. Cl. G06F 9/00; G06F 13/00

(52) U.S. Cl. 710/302

(57) ABSTRACT

The present invention provides a method and apparatus for dynamically configuring processor resources. The method includes processing tasks associated with at least one processor, wherein the processor comprises at least one cache memory having data stored therein. The method further includes transferring at least a portion of the data of the cache memory to another location and removing the processor from a system in response to transferring at least the portion of the data from the cache memory to another location, while the system is in operation.

### BACKGROUND OF THE INVENTION

1. Field of the Invention

This invention relates generally to processor-based systems, and, more particularly, to dynamically configuring processor boards in a distributed, shared-memory, processor-based system.

2. Description of the Related Art

Businesses may use processor-based systems to perform a variety of tasks. These tasks may include, but are not limited to, developing new software, maintaining databases of information related to operations and management, and hosting a web server that may facilitate communications with customers. To handle such a wide range of tasks, businesses may employ a processor-based system used in a network-centric environment.

One example of a processor-based system used in a network-centric environment is a mid-range server system. A single mid-range server system may have a plurality of system boards that may, for example, contain one or more processors and one or more cache memory elements that store copies of frequently used data in close proximity to the one or more processors to provide the one or more processors with faster access to the data. The one or more processors may also include one or more associated non-cache memory elements that may store larger blocks of data.

A mid-range server system, in one embodiment, may employ a distributed shared memory system, where processors from one system board can access data stored in a plurality of non-cache memory elements on the other system boards in the mid-range server system. The union of all of the non-cache memory elements on the system boards of the mid-range server system comprises a distributed shared memory.

In some embodiments, it may be desirable to configure one or more of the plurality of system boards as one or more domains, where a domain, for example, may act as a separate machine by running its own instance of an operating system to perform one or more of the configured tasks. For example, in one embodiment, one domain may be configured as a web server, another as a database server, and a third as a network server. The one or more processors on the one or more of the plurality of system boards in a domain may access data stored in the non-cache memory elements in the domain.

Configuring a domain in a mid-range server system may comprise a variety of tasks including, but not limited to, installing an operating system or other software and adding or subtracting system boards. The number of tasks that any particular domain may be asked to perform may change over time, and it may become desirable to change the configuration, or reconfigure, the domains in a mid-range server system. For example, a business may be able to improve its operational efficiency by reconfiguring the domains in the mid-range server system to remove a system board from a lesser-used domain and allocate it to a more heavily utilized domain.

However, a variety of tasks that may be associated with configuring or reconfiguring resources in a domain may consume processor time and consequently reduce gains in operational efficiency. For example, selected processors in the domain may be using information stored in a non-cache memory element associated with a processor on a board that is scheduled to be reconfigured. As such, reconfiguring the processor may make the data stored in the non-cache memory element unavailable to other processors and may disrupt the operation of the other processors. Thus, it may be desirable to move the data stored in the non-cache memory elements on the board to different memory locations in the domain before reconfiguring the processor. However, transferring the data from the non-cache memory to other memory locations in the domain may consume processing time that could otherwise be used for other tasks and may also introduce errors into the data.

### SUMMARY OF THE INVENTION

In one aspect of the instant invention, a method is provided for dynamically configuring processor resources. The method includes processing tasks associated with at least one processor, wherein the processor comprises at least one cache memory having data stored therein. The method further includes transferring at least a portion of the data of the cache memory to another location and removing the processor from a system in response to transferring at least the portion of the data from the cache memory to another location, while the system is in operation.

In one aspect of the present invention, an apparatus is provided for dynamically reconfiguring processor resources. The apparatus includes at least one processor to execute one or more assigned tasks. The apparatus further includes an interface to couple the apparatus to a system, wherein the apparatus is adapted to be removed from the system in response to executing the one or more assigned tasks, while the system is in operation.

In yet another aspect of the instant invention, an article comprising one or more machine-readable storage media containing instructions is provided for dynamically reconfiguring processor resources. The instructions, when executed, cause a processor to process tasks associated with the processor, wherein the processor comprises at least one cache memory having data stored therein. The instructions, when executed, further cause the processor to transfer at least a portion of the data of the cache memory to another location and to allow the processor to be removed from a system in response to transferring at least the portion of the data from the cache memory to another location, while the system is in operation.

### BRIEF DESCRIPTION OF THE DRAWINGS

The invention may be understood by reference to the following description taken in conjunction with the accompanying drawings, in which like reference numerals identify like elements, and in which:

FIG. 1 shows a stylized block diagram of a system in accordance with one embodiment of the present invention;

FIG. 2 illustrates a block diagram of an exemplary domain configuration that may be employed in the system of FIG. 1, in accordance with one embodiment of the present invention;

FIG. 3 depicts a stylized block diagram of one system board set that may be employed in the system of FIG. 1, in accordance with one embodiment of the present invention;

FIG. 4 depicts a stylized block diagram of an I/O board that may be employed in the system board set of FIG. 3, in accordance with one embodiment of the present invention; and

FIG. 5 illustrates a flow diagram of a method for reconfiguring one or more I/O boards shown in FIG. 4, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

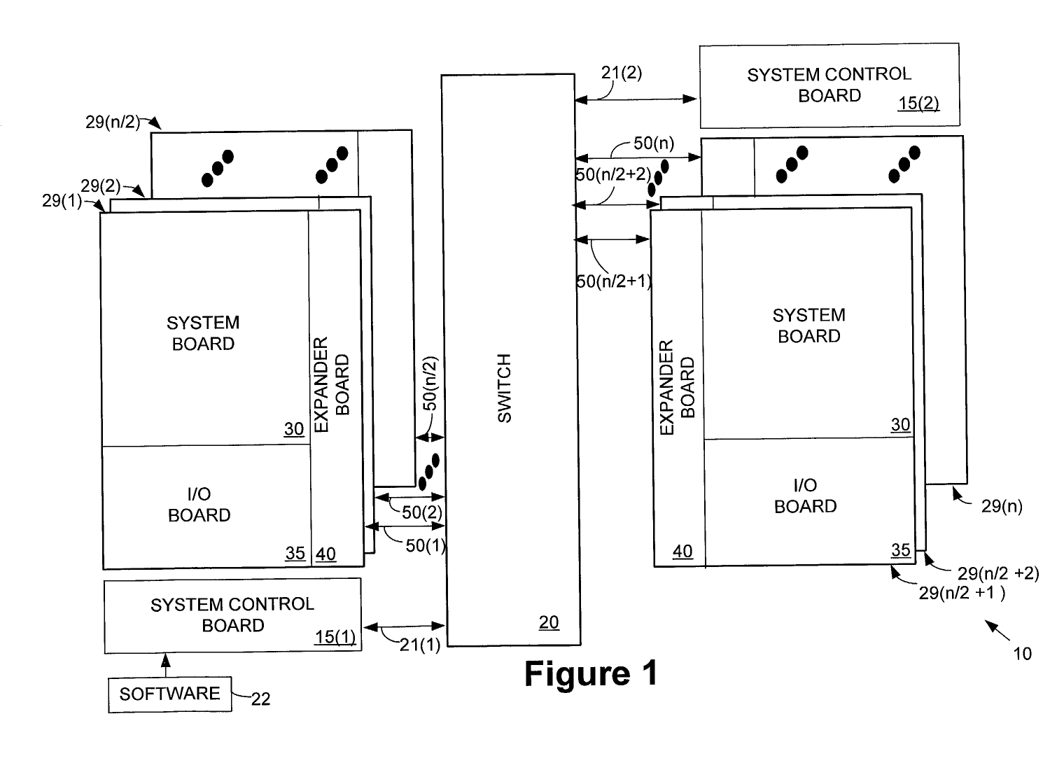

Referring now to FIG. 1, a block diagram of a system 10 in accordance with one embodiment of the present invention is illustrated. The system 10, in one embodiment, includes a plurality of system control boards 15(1-2) that are coupled to a switch 20. For illustrative purposes, lines 21(1-2) are utilized to show that the system control boards 15(1-2) are coupled to the switch 20, although it should be appreciated that, in other embodiments, the boards 15(1-2) may be coupled to the switch in any of a variety of ways, including by edge connectors, cables, or other available interfaces.

In the illustrated embodiment, the system 10 includes two control boards 15(1-2), one for managing the overall operation of the system 10 and the other to provide redundancy and automatic failover in the event that the other board fails. Although not so limited, in the illustrated embodiment, the first system control board 15(1) serves as a “main” system control board, while the second system control board 15(2) serves as an alternate replaceable system control board. In one embodiment, during any given moment, generally one of the two system control boards 15(1-2) actively controls the overall operations of the system 10.

The system 10, in one embodiment, includes a plurality of system board sets 29(1-n) that are coupled to the switch 20, as indicated by lines 50(1-n). The system board sets 29(1-n) may be coupled to the switch 20 in one of several ways, including edge connectors or other available interfaces. The switch 20 may serve as a communications conduit for the plurality of system board sets 29(1-n), half of which may be connected on one side of the switch 20 and the other half on the opposite side of the switch 20.

The switch 20, in one embodiment, may be an 18×18 crossbar switch that allows system board sets 29(1-n) and system control boards 15(1-2) to communicate, if desired. Thus, the switch 20 may allow the two system control boards 15(1-2) to communicate with each other or with other system board sets 29(1-n), as well as allow the system board sets 29(1-n) to communicate with each other.

The system board sets 29(1-n), in one embodiment, comprise one or more boards, including a system board 30, an I/O board 35, and an expander board 40. The system board 30 may include processors, cache memories, and non-cache memories for executing, in one embodiment, applications, including portions of an operating system. The I/O board 35 may manage I/O cards, such as peripheral component interface cards and optical cards, which are installed in the system 10.

The expander board 40, in one embodiment, generally acts as a multiplexer (e.g., 2:1 multiplexer) to allow both the system and I/O boards 30, 35 to interface with the switch 20, which, in some instances, may have only one slot for interfacing with both boards 30, 35. In one embodiment, the system board 30 and the I/O 35 board may, separately or in combination with the expander board 40, be removed from the system 10 by decoupling one or more of the boards 30, 35 from their respective interface slots.

In one embodiment, the system 10 may be dynamically subdivided into a plurality of system domains, where each domain may have a separate boot disk (to execute a specific instance of the operating system, for example), separate disk storage, network interfaces, and/or I/O interfaces. Each domain, for example, may operate as a separate machine that performs a variety of user-configured services. For example, one or more domains may be designated as an application server, a web server, database server, and the like. In one embodiment, each domain may run its own operating system (e.g., Solaris operating system) and may be dynamically reconfigured while the system is in operation without interrupting the operation of other domains. For example, the domain running the database server may be dynamically reconfigured without substantially affecting the function of the domain running the web server.

Dynamic reconfiguration may, in one embodiment, comprise removing one or more system board sets 29(1-n), or elements of a system board set 29(1-n), such as the system board 30 or the I/O board 35, from a domain. Removing an element from the domain may comprise making the element unavailable to the domain while the element remains in the system 10 or physically removing the element from the system 10. As will be described in more detail below, in accordance with one or more embodiments of the present invention, dynamically configuring or reconfiguring a I/O board 35 comprising one or more processors may save processor time that may be used to transfer data stored in the non-cache memories and may reduce the chance that errors will be introduced during the reconfiguration. As such, the overall performance efficiency of system 10 may be improved.

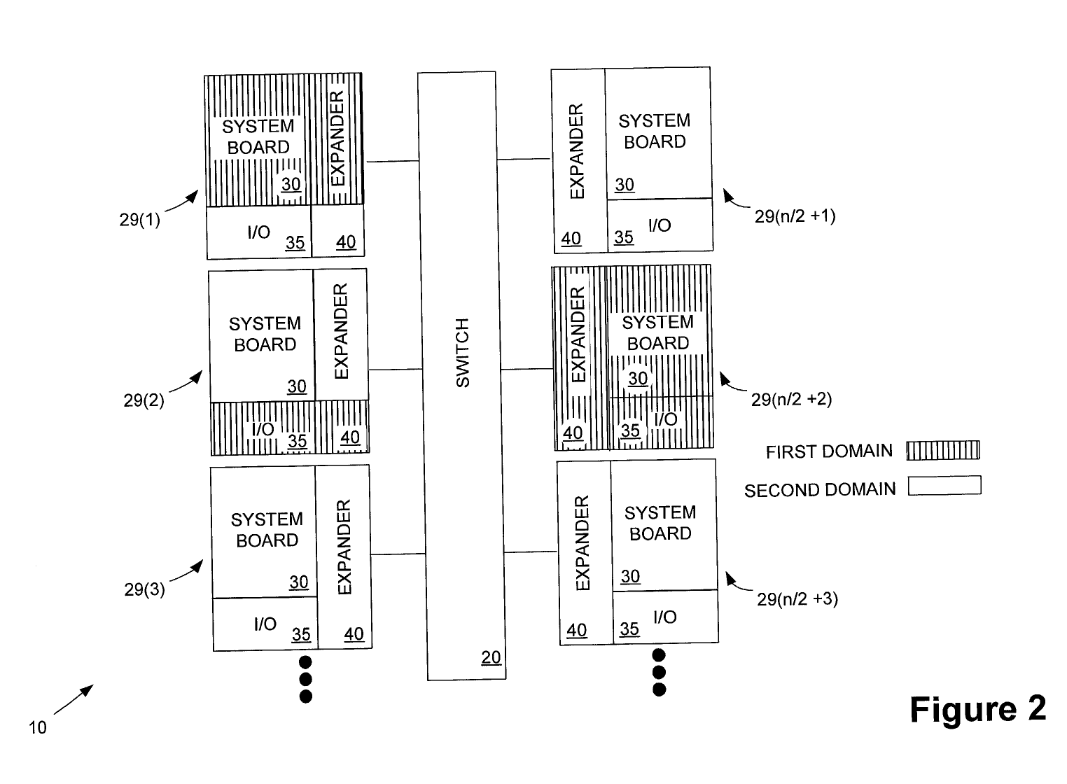

FIG. 2 illustrates an exemplary arrangement where at least two domains are defined in the system 10. The first domain, identified by vertical cross-sectional lines, includes the system board set 29(n/2+2), the system board 30 of the system board set 29(1), and the I/O board 35 of the system board set 29(2). The second domain in the illustrated embodiment includes the system board sets 29(3), 29(n/2+1), and 29(n/2+3), as well as the I/O board 35 of the system board set 29(1) and the system board 30 of the system board set 29(2).

As shown, a domain may be formed of an entire system board set 29(1-n), one or more boards (e.g., system board 30, I/O board 35) from selected system board sets 29(1-n), or a combination thereof. Although not necessary, it may be possible to define each system board set 29(1-n) as a separate domain. For example, if each system board set 29(1-n) were its own domain, the system 10 may conceivably have up to “n” (i.e., the number of system board sets) different domains. When two boards (e.g., system board 30, I/O board 35) from the same system board set 29(1-n) are in different domains, such a configuration is referred to as a “split expander.” The expander board 40 of the system board sets 29(1-n), in one embodiment, keeps the transactions separate for each domain. No physical proximity may be needed for boards in a domain.

Domains in the system 10 may be dynamically reconfigured. The process of dynamic reconfiguration may comprise removing one or more system board sets 29(1-n), one or more system boards 30, or one or more I/O boards 35 from the domain. As the term is used in the present context, “removing” should be understood to mean decoupling one or more boards 30, 35 or system board sets 29(1-n) from the domain, physically removing the one or more boards 30, 35 or system board sets 29(1-n) from the system 10, or any other desirable action that substantially makes the one or more boards 30, 35 or system board sets 29(1-n) unavailable to perform operations in the domain.

Although it is not necessary, the system 10 may be operational during the process of dynamically reconfiguring domains. Consequently, it may be desirable to have the system control boards 15(1-2) isolate the one or more boards 30, 35 before removing one or more of the boards 30, 35 from domains in the system 10. To isolate an I/O board 35, for example, the system control boards 15(1-2) may stop assigning tasks to the elements on the I/O board 35 and then wait until the I/O board 35 has substantially completed any current tasks.

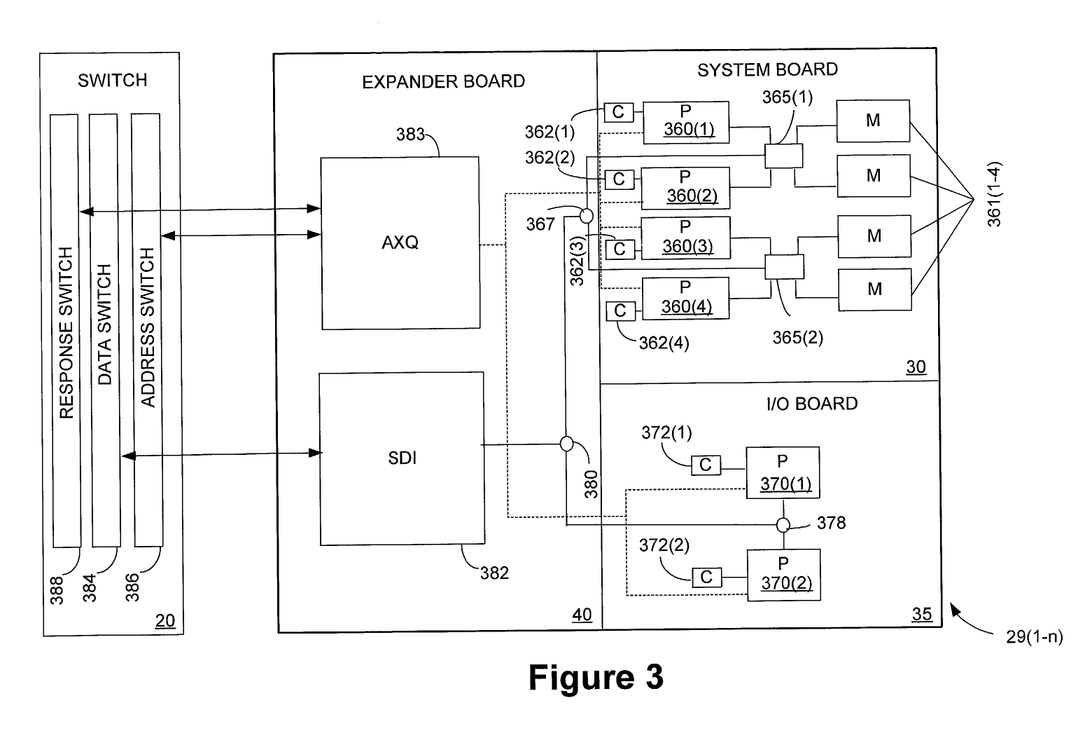

Referring now to FIG. 3, a block diagram of the system board set 29(1-n) coupled to the switch 20 is illustrated, in accordance with one embodiment of the present invention. The system board 30 of each system board set 29(1-n) in the illustrated embodiment includes four processors 360(1-4), with each of the processors 360(1-4) having a non-cache memory 361(1-4). In one embodiment, each of the processors 360(1-4) may also be coupled to a respective cache memory 362(1-4). In other embodiments, each of the processors 360(1-4) may have more than one associated cache memories, wherein some or all of the one or more cache memories may reside within the processors 360(1-4).

The processors 360(1-4), in one embodiment, may be able to access their own respective non-cache memories 361(1-4) and cache memories 362(1-4), as well as access the memories associated with other processors on boards in the same domain. In one embodiment, two five-port, dual-data switches 365(1-2) connect the processor/memory pairs (e.g., processors 360(1-2)/memories 361(1-2) and processors 360(3-4)/memories 361(3-4)) to a board data switch 367.

In one embodiment, the operating system executing in a particular domain may assign tasks to the processors 360(1-4) in that domain. The processors 360(1-4) in a domain may be capable of performing a single or multiple assigned tasks at any given time. In one embodiment, for example, the processors 360(1-4) may perform in a serial manner, completing a first assigned task before starting on a second assigned task. Alternatively, the processors 360(1-4) may handle multiple tasks and perform out-of-order processing of these tasks. For example, in one embodiment, the processors 360(1-4) may begin executing the first assigned task. The first task may, however, require the processors 360(1-4) to wait for data. In that situation, the processors 360(1-4) may temporarily stop performing the first task and begin executing the second task while the first task is pending. The tasks assigned to the processors 360(1-4), whether being executed or waiting to be executed, are herein referred to as the “current tasks.”

Although not so limited, the I/O board 35 of each system board set 29(1-n) in the illustrated embodiment may include two processors 370(1-2). In one embodiment, each of the processors 370(1-2) may be coupled to a cache memory 372(1-2). In other embodiments, each of the processors 370(1-2) may have more than one associated cache memory, wherein some or all of the one or more cache memories may reside within the processors 370(1-2). The I/O board 35, in one embodiment, may have only cache memory, (i.e. no non-cache memory). In another embodiment, the only memory the I/O board may have is memory that resides on the same die as the processors 370(1-2). In one embodiment, the processors 370(1-2) may perform one or more current tasks that may be assigned by the operating system and may be able to access their own respective cache memories 372(1-2). The processors 370(1-2) may also be able to access cache and non-cache memories on other boards in the domain.

The two processors 370(1-2) of the I/O board 35, in one embodiment, are coupled to a data switch 378. A switch 380 in the expander board 40 receives an output signal from the switch 378 of the I/O board 35 and from the switch 367 of the system board set 29(1-n) and, in one embodiment, provides it to an System Data Interface (SDI) 382. The SDI 382 may process data transactions to and from the switch 20 and the system and I/O boards 30 and 35. A separate address path (shown in dashed lines) is shown from the processors 360(1-4) and the processors 370(1-2) to an Address Expander Queue (AXQ) module 383. The AXQ module 383 may process address and response transactions to and from the switch 20 and the system and I/O boards 30 and 35.

In one embodiment, the switch 20 may include a data switch 384, an address switch 386, and a response switch 388 for transmitting respective data, address, and control signals provided by the SDI 382 and the AXQ module 383 of each expander board 40 of the system board sets 29(1-n). Thus, in one embodiment, the switch may include three 18×18 crossbar switches that provide a separate data path, address path, and control signal path to allow intra- and inter-domain communications. Using separate paths for data, addresses, and control signals, in one embodiment, may reduce the interference among traffic on the data path, address path, and control signal path. In one embodiment, the switch 20 may provide a bandwidth of about 43 Gigabytes per second. In other embodiments, a higher or lower bandwidth may be achieved using the switch 20.

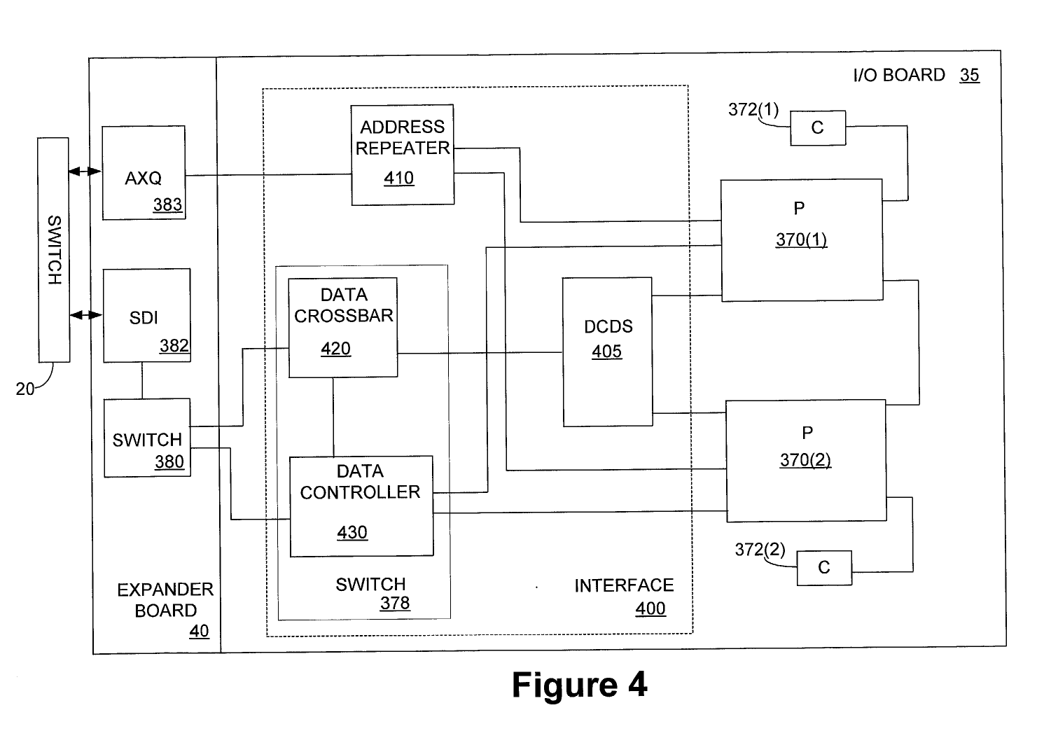

FIG. 4 depicts a stylized block diagram of one embodiment of the I/O board 35. In one embodiment, the I/O board 35 may be coupled to the expander board 40 through an interface 400 that may comprise a switch 378, a dual CPU data switch (DCDS) 405, and an address repeater 410. In one embodiment, the switch 378 may comprise a data crossbar 420 and a data controller 430. It should be noted, however, that the arrangement and/or location of various components on the I/O board 35 is matter of design choice, and thus may vary from one implementation to another. Additionally, more or fewer components may be employed without deviating from the spirit and scope of one or more embodiments of the present invention.

The one or more processors 370(1-2) may be coupled to the DCDS 405, which may receive data from the one or more processors 370(1-2) and transmit the data to the switch 378 through a single connection. The DCDS 405 may also direct information from the switch 378 to one of the two processors 370(1-2). The one or more processors 370(1-2) on the I/O board 35 may also be coupled to the address repeater 410. In one embodiment, the address repeater 410 may receive address requests from the one or more processors 370(1-2). The address repeater 410 may then transmit the requests to the AXQ module 383 on the expander board 40. The address repeater 410 may also receive address requests from other processors in the domain and pass them to the one or more processors 370(1-2) on the I/O board 35.

The one or more processors 370(1-2) may communicate with the rest of the domain by providing requests through the interface 400. For example, in one embodiment, the one or more processors 370(1-2) may retrieve data from cache 362(1-4) and non-cache 361(1-4) memories in the domain by providing a request to the address repeater 410, which may pass the request from the I/O board 35 to the AXQ module 383 on the expander board 40. The AXQ module 383 may then transmit the request to one or more other processors in the domain, which may locate the data and send the data back to the switch 378 on the I/O board 35 through the SDI 382 and the switch 380.

When a response to the request arrives at the switch 378, the data controller 430 may, in one embodiment, determine which of the one or more processors 370(1-2) made the request. The data controller 430 may then direct the data crossbar 420 to transmit any data that may be contained in the response through the DCDS 405 to the appropriate processor 370(1-2). The processors 370(1-2) may store the received data in the one or more associated cache memories 372(1-2). Requests from other processors belonging to the same domain to access data stored in the cache memories 372(1-2) may also be processed through the same interface 400.

During the operation of the system 10, it may become desirable to dynamically reconfigure one or more I/O boards 35 in a given domain. For example, a user may wish to move an under-utilized I/O board 35 from one domain to another domain. As another example, a system administrator may desire to replace a damaged I/O board 35 in the system 10.

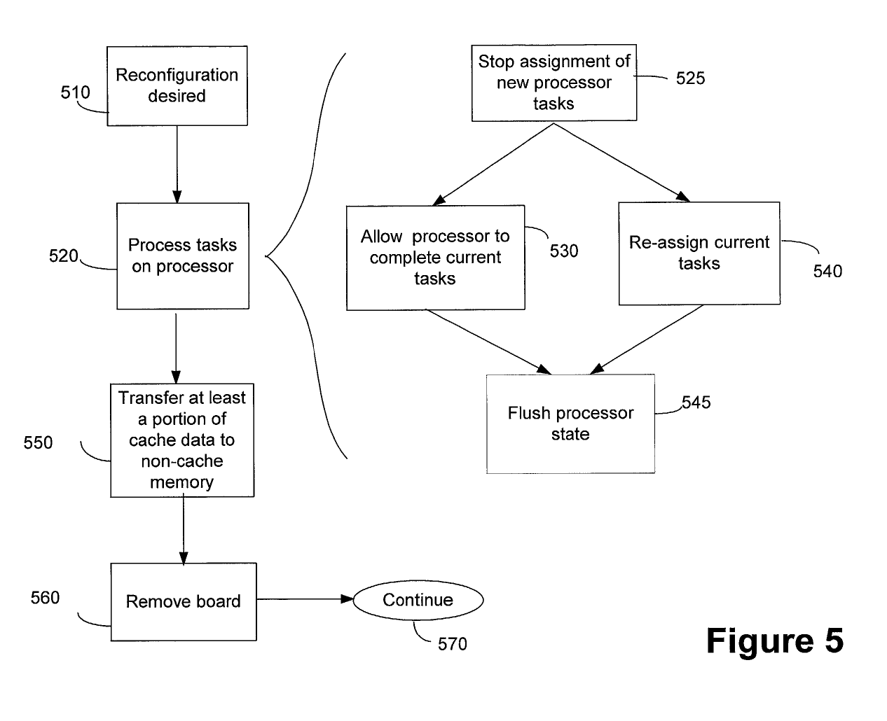

FIG. 5 illustrates a flow diagram of one embodiment of the method for reconfiguring one or more of the I/O boards 35 in system 10. An administrator, for example, may determine that a reconfiguration of resources, such as the I/O board 35, within a domain of the system 10 may be desired (at 510). As such, before the I/O board 35 may be removed from a particular domain, it may be desirable to process (at 520) any current tasks that may be scheduled to be performed by the one or more processors 370(1-2). In one embodiment, processing (at 520) the current tasks scheduled for the one or more processors 370(1-2) on the I/O board 35 may comprise stopping (at 525) the assignment of new tasks to the one or more processors 370(1-2). As mentioned above, in one embodiment, the operating system may stop assigning new tasks to the one or more processors 370(1-2).

The current tasks of the one or more processors 370(1-2) may comprise tasks being performed and pending tasks waiting to be performed. As such, processing (at 520) the current tasks may, in one embodiment, comprise allowing the processors 370(1-2) to substantially complete (at 530) both the tasks being performed and the pending tasks. However, it may not always be desirable to wait until the pending tasks are substantially complete before proceeding with reconfiguration. Thus, in alternative embodiments, processing (at 520) the current tasks may comprise reassigning (at 540) pending tasks to other processors in the domain. Reassigning (at 540) the pending tasks may, for example, allow the one or more processors 370(1-2) to complete their tasks in a shorter time and reduce the time that may elapse before the I/O board 35 can be removed from the domain.

Once the current tasks have been substantially processed (at 520), the processors 370(1-2) may retain information reflecting the current state of components of the processor 370(1-2), such as internal registers and the like. In order for other processors in the domain to accurately resume processes that may have been pending on the processors 370(1-2), the information reflecting the current state may be flushed (at 545). For example, the contents of internal registers in the processors 379(1-2) may be flushed (at 545) to other memory elements in the domain.

Other processors (not shown) in the domain may need access to the data stored in the cache memories 372(1-2). Consequently, removing the I/O board 35 may disrupt the operation of the other processors in the domain. It may thus be desirable to transfer (at 550) some or all of the data stored in the cache memory 372(1-2) to non-cache memories on other boards in the domain. In one embodiment, only data in the cache memory 372(1-2) that has been updated by the processor 370(1-2) may be transferred to the non-cache memory. In other embodiments, however, all of the data stored in the cache memory 372(1-2) may be transferred to non-cache memory.

When the one or more processors 370(1-2) have substantially completed the current tasks and some or all of the data in the cache memories 372(1-2) have been substantially transferred to non-cache memories on other boards in the domain, the I/O board 35 may be removed (at 560) from the domain. The domain of the system 10 may then continue (at 570) with other operations. It should, however, be noted that the sequence of events that may be used to isolate and remove an I/O board 35 is a matter of design implementation, and thus may vary from one implementation to another. Additionally, more or fewer actions may be performed without deviating from the spirit and scope of one or more embodiments of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
processing tasks associated with at least one processor, wherein the processor comprises at least one cache memory having data stored therein;
transferring at least a portion of the data of the cache memory to another location; and
removing the processor from a system in response to transferring at least the portion of the data from the cache memory to another location, while the system is in operation.

2. The method of claim 1, wherein transferring at least the portion of the data of the cache memory to another location comprises transferring at least the portion of the data of the cache memory to non-cache memory in the system.

3. The method of claim 2, the system comprising a domain defined therein, wherein transferring at least the portion of the data comprises transferring at least the portion of the data of the cache memory of the domain to non-cache memory of the domain in the system.

4 The method of claim 3, wherein removing the processor from the system comprises removing a board comprising the processor and the cache memory from the system.

5. The method of claim 4, wherein removing the board comprises removing the board from the domain in the system.

6. The method of claim 1, wherein processing the tasks associated with the at least one processor comprises stopping new tasks from being assigned to the processor.

7. The method of claim 6, wherein processing the tasks comprises allowing the processor to substantially complete current tasks.

8. The method of claim 7, wherein processing the tasks comprises flushing the current state of the processor.

9. The method of claim 8, wherein processing the tasks comprises sending an acknowledgement signal indicating that it is safe to remove the board.

10. The method of claim 8, wherein transferring at least a portion of the data comprises transferring all of the data stored in the cache memory.

11. An apparatus, comprising:
at least one processor to execute one or more assigned tasks; and
an interface to couple the apparatus to a system, wherein the apparatus is adapted to be removed from the system in response to executing the one or more assigned tasks, while the system is in operation.

12. The apparatus of claim 11, wherein the processor comprises at least one associated cache memory element having data stored therein.

13. The apparatus of claim 12, wherein the device is adapted to be removed from the system in response to transferring a portion of the data of the cache memory to a non-cache memory external to the apparatus.

14. The apparatus of claim 13, wherein the portion of the data comprises all the data stored in the cache memory.

15. The apparatus of claim 11, wherein the processor is adapted to transmit a signal to the system when the processor has substantially completed the one or more assigned tasks.

16. A system, comprising:
an interface adapted to receive a first processor and an associated cache memory;
a control unit adapted to cause at least a portion of the contents of the associated cache memory to be transferred to a second memory location and, in response to the transfer, the first processor to be removed from a domain of the system, while the system is in operation.

17. The system of claim 16, wherein the domain comprises at least one additional processor that continues to operate for at least a selected duration after the removal of the first processor.

18. The system of claim 17, wherein the second memory location comprises a non-cache memory in the domain.

19. The system of claim 18, wherein the second processor is further adapted to stop the assignment of additional tasks to the first processor.

20. The system of claim 19, wherein the second processor is further adapted to allow the first processor to substantially complete current tasks.

21. The system of claim 20, wherein the second processor is adapted to reassign current tasks.

22. The system of claim 21, wherein the second processor is adapted to flush the current state of the first processor.

23. A system, comprising:
a first board having a memory element;
a second board having a processor and only a cache memory element, wherein the processor is adapted to execute one or more current tasks;
a control unit adapted to receive an indication to dynamically remove the second board from a domain of the system, wherein the control unit, in response to receiving the indication, is adapted to process at least one current task associated with the processor and transfer at least a portion of data stored in the cache memory on the second board to the memory element on the first board.

24. The system of claim 23, wherein the control unit is adapted to allow the processor on the second board to complete the one or more current tasks.

25. The system of claim 24, wherein the first board comprises a processor and wherein the control unit is adapted to reassign at least one of the current tasks associated with the processor of the second board to the processor of the first board.

26. An apparatus, comprising:
at least two processors, wherein each processor has at least one associated cache memory but no non-cache memory;
an address repeater coupled to the two processors, wherein the address repeater is adapted to receive at least one data request and to provide the request to at least one of the two processors;
a data crossbar;
a dual CPU data switch coupled to the two processors and the data crossbar, wherein the dual CPU data switch is adapted to provide data from at least one of the cache memories of the two processors to the data crossbar in response to the received data request; and
a data controller coupled to the data crossbar, wherein the data controller is adapted to indicate to the data crossbar where to send the requested data.

27. The apparatus of claim 26, wherein at least one of the two processors is adapted to send data address requests through the address repeater and receive the requested data through the data crossbar and dual CPU data switch.

28. An article comprising one or more machine-readable storage media containing instructions that when executed enable a processor to:
process tasks associated with the processor, wherein the processor comprises at least one cache memory having data stored therein;
transfer at least a portion of the data of the cache memory to another location; and
allow the processor to be removed from a system in response to transferring at least the portion of the data from the cache memory to another location, while the system is in operation.

29. The article of claim 28, wherein the instructions when executed enable the processor to transfer at least the portion of the data of the cache memory to non-cache memory in the system.

30. The article of claim 29, wherein the instructions when executed enable the processor to transfer at least the portion of the data of the cache memory of the domain to non-cache memory of the domain in the system.

31. The article of claim 30, wherein the instructions when executed enable the processor to allow a board comprising the processor and the cache memory to be removed from the system.

32. The article of claim 31, wherein the instructions when executed enable the processor to allow the board to be removed from a domain in the system.
